(19) United States
(12) Patent Application Publication
(10) Pub. No.: US 2020/0324396 A1
(43) Pub. Date: Oct. 15, 2020

(54) METHOD AND APPARATUS FOR VALVE CAP REMOVAL

(71) Applicant: Theodore R. McDOWELL, Skokie, IL (US)

(72) Inventor: Theodore R. McDOWELL, Skokie, IL (US)

(21) Appl. No.: 16/835,689

(22) Filed: Mar. 31, 2020

Related U.S. Application Data
(60) Provisional application No. 62/832,194, filed on Apr. 10, 2019.

(51) Int. Cl. B25B 13/50; F16K 24/02; B25B 23/00; G10D 9/04

(52) U.S. Cl. CPC B25B 13/5008; G10D 9/04; B25B 23/0035; F16K 24/02

(57) ABSTRACT

An apparatus is shown for removing valve caps from an instrument. A chamber is formed along a longitudinal axis of a rigid tool body, where the chamber includes an opening formed in a first end of the tool body for receiving a bottom cap of a valve of the instrument. An inner wall surface of the chamber tapers from the opening of the tool body such that a cross sectional radius of the chamber reduces with respect to the longitudinal axis. Splines are formed in the internal wall surface for engaging knurls on a bottom cap of the valve. The splines can have a cross section that is V shaped semi-circular or scalloped. The tool body can include a shank or openings formed in a second end of the tool body using a driver to apply torque to the tool body.

### CROSS REFERENCE TO RELATED APPLICATIONS

This application claims the benefit of U.S. Provisional Patent Appl. No. 62/832,194 for “METHOD AND APPARATUS FOR VALVE CAP REMOVAL” filed Apr. 10, 2019, herein incorporated by reference in its entirety for all purposes.

### BACKGROUND

Brass musical instruments typically include valves that are manipulated by a musician to change the tone of the sound produced by the instrument. Valves, e.g. pistons, are typically secured within valve casings of the instrument by threaded top and bottom caps. The valves accumulate moisture, including moisture in the valves, due to water vapor in the musician's breath that is expelled into the instrument. Bottom caps catch the moisture that drains from the valves.

The accumulated moisture often causes corrosion in the instrument that impairs the valve function. As a result, the instrument will require maintenance and repair from time to time, which typically involves removing the valves from the instrument. However, the corrosion can also make valve cap removal difficult and often requires the application of significant force to the valve cap to remove it from the instrument. The position of the valve cap relative to other parts of the instrument can inhibit the application of the adequate force to a valve cap, e.g. valve bottom cap, to remove it from the instrument.

It is with respect to these and other considerations that the disclosure made herein is presented.

### SUMMARY

Disclosed is an apparatus and method for removing valve caps from an instrument. The apparatus is a tool, such as a socket, with a chamber formed along a longitudinal axis of the tool, where the chamber includes an opening formed in a first end of the tool for receiving a bottom cap of a valve. An inner wall surface of the chamber is tapered from the opening of the tool so that a cross sectional radius of the chamber reduces with respect to the longitudinal axis. The internal wall surface has grooves formed therein for engaging knurls on the bottom cap of the valve.

The tool is applied to the bottom cap of the valve such that the bottom cap is inserted into the chamber until the knurls of the bottom cap engage the grooves of the inner wall surface. Rotational torque is applied to the tool, which transfers the torque to the bottom cap of the valve in order to remove the bottom cap.

One example of the disclosed technology includes an apparatus for removing valve caps from an instrument. The apparatus has a rigid tool body and a chamber is formed along a longitudinal axis of the tool body that has an opening formed in a first end of the tool body for receiving a bottom cap of a valve. An inner wall surface of the chamber tapers from the opening of the tool body such that a cross sectional radius of the chamber reduces with respect to the longitudinal axis. Splines are formed in the internal wall surface for engaging knurls on a bottom cap of the valve.

In some examples, the splines are formed with a V shaped cross section. In other examples, the splines are formed with a semi-circular or scalloped cross section.

In certain examples, the tool body includes a shank formed in a second end of the tool body that is opposite the first end, where the shank is configured to receive a driver for applying torque to the tool body. In yet other examples, the tool body openings formed in a second end of the tool body that is opposite the first end, where the openings are configured to receive a driver for applying torque to the tool body. In particular examples, the apparatus has at least twenty-four splines.

Another example of the disclosed technology involves a method for removing valve caps from an instrument that includes providing an apparatus having a rigid tool body with a chamber formed therein along a longitudinal axis of the tool body. The chamber includes an opening formed in a first end of the tool body for receiving a bottom cap of a valve. An inner wall surface of the chamber is tapered from the opening of the tool body such that a cross sectional radius of the chamber reduces with respect to the longitudinal axis. Splines are formed in the internal wall surface for engaging knurls on a bottom cap of a valve. The method also involves applying the apparatus to the bottom cap of the valve such that the knurls of the bottom cap are engaged by the plurality of splines and applying rotational torque to the tool body to remove the bottom cap.

In some examples, the method involves forming one or more holes in a second end of the tool body that is opposite the first end of the tool body. In these examples, applying rotational torque to the tool body to remove the bottom cap involves inserting a bit of a driver into at least one of the holes in the second end of the tool body and applying force to the driver to provide rotational torque to the tool body. In particular examples, the driver can be a ratchet driver, an impact driver, a spanner wrench or a knockout punch.

In other examples, the method involves forming a shank in a second end of the tool body that is opposite the first end. In these examples, applying rotational torque to the tool body to remove the bottom cap involves applying a wrench to the shank and applying force to the wrench to provide rotational torque to the tool body.

### BRIEF DESCRIPTION OF THE DRAWINGS

Various embodiments in accordance with the present disclosure will be described with reference to the drawings, in which:

FIG. 1A is a side view schematic diagram that illustrates one example of an apparatus for valve cap removal according to certain aspects of the present invention;

FIG. 1B is a perspective view schematic diagram of the example of FIG. 1A;

FIG. 1C is an end view schematic drawing of the example of FIGS. 1A and 1B for valve cap removal having V shaped grooves according to certain aspects of the present invention;

FIG. 2A is a side view schematic diagram that illustrates an example of an apparatus for valve cap removal oriented to engage a knurled valve bottom cap according to certain aspects of the present invention;

FIG. 2B is a cut away side view schematic diagram that illustrates an example of an apparatus for valve cap removal engaged with a valve bottom cap and driven by a ratchet drive according to certain aspects of the present invention;

FIG. 3A is a perspective view schematic diagram that illustrates another example of an apparatus for valve cap removal according to certain aspects of the present invention;

FIG. 3B is a cut away side view schematic diagram of the example of FIG. 3A;

a schematic drawing illustrating one example of the relative size, position and dimensions for features and each end of tool 300 with respect to a body 310

FIG. 3C is a schematic diagram illustrating one example of the relative dimensions for size, position and dimensions for features and each end with respect to a body of the example of FIGS. 3A and 3B;

FIG. 4A is a perspective view schematic diagram illustrating another example of dimensions for an apparatus for valve cap removal having additional holes formed in a drive end to accommodate a spanner wrench or a knockout punch according to certain aspects of the present invention;

FIG. 4B is a cut away side view schematic diagram of the example of FIG. 4A;

FIG. 4C is a schematic diagram illustrating one example of the relative dimensions for size, position and dimensions for features and each end with respect to a body of the example of FIGS. 4A and 4B;

FIG. 5 is a schematic diagram illustrating an example of an apparatus for valve cap removal engaged with a valve bottom cap and driven by an impact driver according to certain aspects of the present invention;

FIG. 6A is a perspective view schematic diagram illustrating another example of dimensions for an apparatus for valve cap removal having rounded or scalloped splines according to certain aspects of the present invention;

FIG. 6B is a cut away side view schematic diagram of the example of FIG. 6A;

FIG. 6C is a schematic diagram illustrating one example of the relative dimensions for size, position and dimensions for features and each end with respect to a body of the example of FIGS. 6A and 6B; and

FIG. 7 is a table illustrating additional dimensions for examples of different sized sockets.

Note that the same or similar numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements and may be used in conjunction with other existing or future technologies. This description should not be interpreted as implying any particular arrangement or configuration of the elements except when the arrangement or configuration is explicitly described.

Examples are discussed herein of an apparatus and method for valve cap removal from an instrument, such as a musical instrument. The apparatus is a tool, such as a socket, with a chamber formed along a longitudinal axis of the tool, where the chamber includes an opening formed in a first end of the tool for receiving a bottom cap of a valve, such as a knurled bottom cap of a trumpet valve.

An inner wall surface of the chamber is tapered from the opening of the tool so that a cross sectional radius of the chamber reduces with respect to the longitudinal axis. The taper of the inner wall surface can provide for the tool to accommodate different sizes and configurations of valve bottom caps.

The internal wall surface has splines formed therein for frictionally engaging knurls on the bottom cap of the valve. The splines can have different cross-sectional profiles, such as V shaped, semi-circular or scalloped.

The tool is applied to the bottom cap of the valve such that the bottom cap is inserted into the chamber until the knurls of the bottom cap engage the splines of the inner wall surface. Rotational torque is applied to the tool, such as using a ratchet drive, square shank L wrench, hex key, impact driver, spanner wrench or knock out punch coupled to the tool, which transfers the torque to the bottom cap of the valve in order to remove the bottom cap.

Using the apparatus, a bottom cap of a valve can be removed even when there is significant corrosion in the valve or the valve is difficult to access due to its position on the instrument.

The foregoing and other features and advantages of certain examples of the present invention will be more readily apparent from the following detailed description, which proceeds with references to the accompanying drawings. In the following detailed description, references are made to the accompanying drawings that form a part hereof, and in which are shown by way of illustration specific configurations or examples.

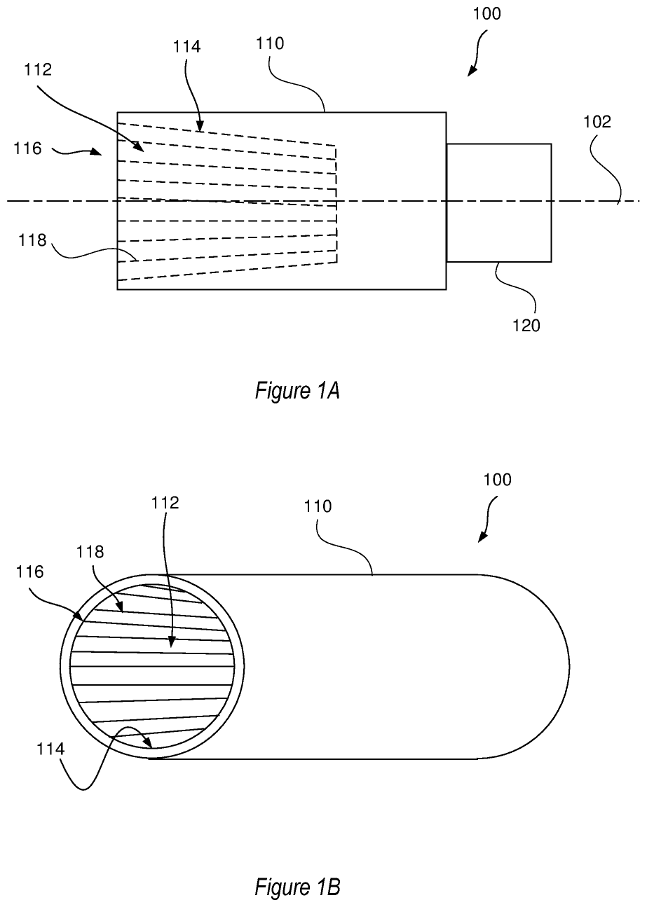

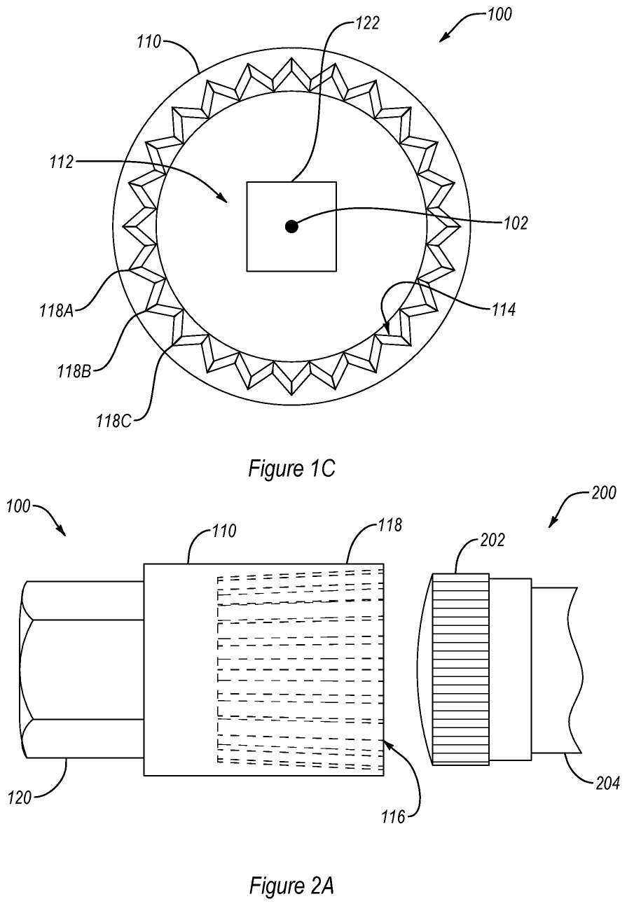

FIG. 1A is a side view schematic diagram that illustrates one example of an apparatus or tool 100 for valve cap removal according to certain aspects of the present invention. Tool 100 has a body 110, which can be metal or another durable material, with a chamber 112 formed therein along a longitudinal axis 102 of the tool, where the chamber 112 includes at an opening 116 formed in a first end of the tool 100 for receiving a bottom cap of a valve, such as a knurled bottom cap of a trumpet valve.

An inner wall surface 114 of the chamber 112 is tapered from the opening 116 of the chamber 112 toward a second end of tool 100 having a shank 120 of the tool 100 so that a cross sectional radius of the chamber 112 reduces with respect to the longitudinal axis. The taper of the inner wall surface 114 can provide for the tool 100 to accommodate different sizes and configurations of valve bottom caps.

The internal wall surface 114 has a plurality splines 118 formed longitudinally therein for engaging knurls on the bottom cap of the valve. The splines can have different cross-sectional profiles, such as V shaped, rounded or scalloped, which is illustrated in further detail below.

FIG. 1B is a perspective view schematic diagram of the example of FIG. 1A. The perspective view illustrates chamber 112 formed in body 110, where the chamber 112 includes at an opening 116 for receiving a knurled valve bottom cap. The perspective view also illustrates tapered inner wall surface 114 within which a plurality of splines 118 are formed for engaging a bottom cap.

FIG. 1C is an end view schematic drawing of the tool 100 of the example of FIGS. 1A and 1B for valve cap removal having V shaped grooves or splines 118A, 118B and 118C according to certain aspects of the present invention. The end view illustrates chamber 112 formed in body 110 centered on longitudinal axis 102. Chamber 112 includes opening 116 for receiving a knurled valve bottom cap.

The perspective view also illustrates tapered inner wall surface 114 within which splines 118A, 118B and 118C are formed for engaging a bottom cap. Splines 118 are formed in inner surface wall 114 along the inner circumference of chamber 112. The number of splines can be different for differing implementations. For example, more splines in a tool 100 configured to engage a bottom cap having more knurls. This example also includes a spare opening formed at the second end of tool 100 for receiving a driving tool, such as a ratchet drive.

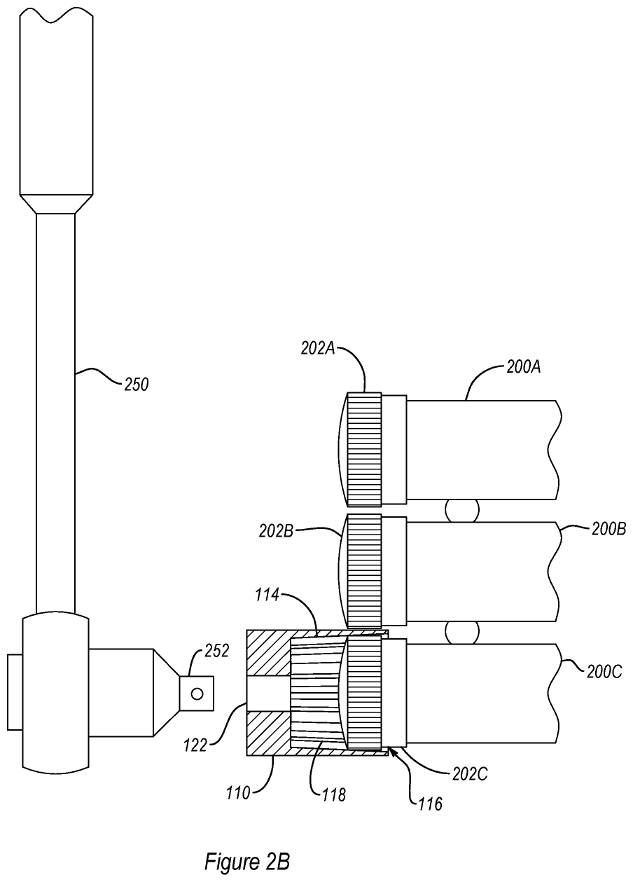

FIG. 2A is a side view schematic diagram that illustrates an example of an apparatus or tool 100 for valve cap removal oriented to engage a knurled valve bottom cap 200 according to certain aspects of the present invention. In this example, a hexagonal shank is provided in the apparatus to allow a socket or end wrench to be used to drive the apparatus 100 to apply torque. The apparatus is positioned to insert the knurled bottom cap within the chamber of the apparatus so that the splines in the inner surface of the chamber engage the knurls in the bottom cap. A driver can be applied to apparatus in order to assert torque on the bottom cap.

Tool 100 can be applied to valve cap 200 such that the valve cap is inserted into opening 116 in tool 100 until knurls 202 on valve cap 200 engage splines 118 formed in tool 100. The tool 100 can be rotated, such as using shank 120, such that the splines 118 grip knurls 202 and rotate the cap 200, which permits cap 200 to be removed from valve 204.

FIG. 2B is a cut away side view schematic diagram that illustrates an example of an apparatus 100 for valve cap removal engaged with a valve bottom cap 200C and driven by a ratchet drive 250 according to certain aspects of the present invention. In this example, bit driver 252 of ratchet drive 250 can be inserted into opening 122 formed in the apparatus in order to rotate the apparatus.

The cutaway perspective of FIG. 2B illustrates knurls 202C of valve bottom cap 200C engaged by splines 118 formed on inner surface 114. Driver 250 can be used to drive the tool via bit 252 when inserted in opening 122 to cause the tool to rotate. As the tool rotates, splines 118 engage knurls 202C to force the bottom cap to rotate for removal.

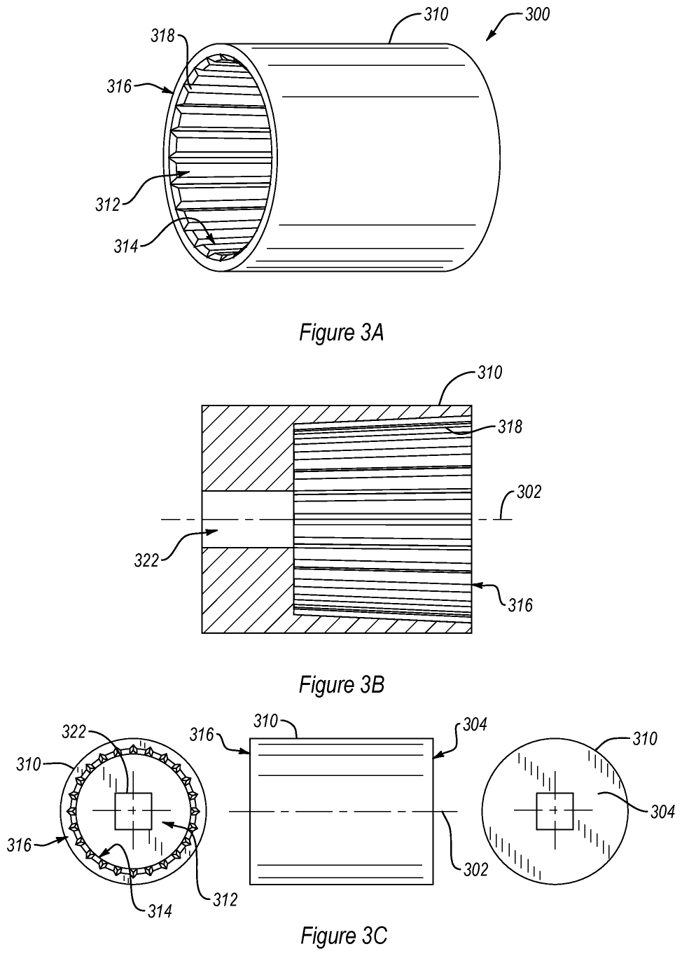

FIG. 3A is a perspective view schematic diagram that illustrates another example of an apparatus 300 for valve cap removal according to certain aspects of the present invention having twenty-four splines 318 formed in the inner surface 314 of the apparatus that are set apart from one another and have a V shaped cross section. The angle of the V shaped cross section of splines 318 can vary without departing from the teachings of the present disclosure.

Tool 300 has a body 310, which can be metal or another durable material, with a chamber 312 formed therein along a longitudinal axis 302 of the tool, where the chamber 312 includes at an opening 316 formed in a first end of the tool 300 for receiving a bottom cap of a valve, such as a knurled bottom cap of a trumpet valve.

An inner wall surface 314 of the chamber 312 is tapered from the opening 316 of the chamber 312 toward a second end 304 of tool 300 so that a cross sectional radius of the chamber 312 reduces with respect to the longitudinal axis. The taper of the inner wall surface 314 can provide for the tool 300 to accommodate different sizes and configurations of valve bottom caps.

The perspective view of FIG. 3A illustrates chamber 312 formed in body 310, where the chamber 312 includes at an opening 316 for receiving a knurled valve bottom cap. The perspective view also illustrates tapered inner wall surface 314 within which a plurality of splines 318 are formed for engaging a bottom cap.

FIG. 3B is a cut away side view schematic diagram of the apparatus 300 for valve cap removal example of FIG. 3A. Tool 300 can be applied to a valve cap inserted into opening 316 in tool 300 until the knurls of a valve cap engage splines 318 formed in tool 300. The tool 300 can be rotated, such as using a bit driver 252 of ratchet drive 250 or another driver tool or wrench inserted into opening 322 formed in the apparatus in order to rotate the apparatus 300, such that the splines 318 grip the knurls of a valve cap and rotate the cap to remove it from a valve.

FIG. 3C is a schematic drawing illustrating one example of the relative size, position and dimensions for features and each end of tool 300 with respect to a body 310 of the example apparatus 300 of FIGS. 3A and 3B in accordance with certain examples of the disclosed solution. In this example, the end view illustrates chamber 312 formed in body 310 centered on longitudinal axis 302. Chamber 312 includes opening 316 for receiving a knurled valve bottom cap.

The end view also illustrates tapered inner wall surface 314 within which splines 318 are formed for engaging a bottom cap. Splines 318 are formed in inner surface wall 314 along the inner circumference of chamber 312. The number of splines can be different for differing implementations. For example, more splines in a tool 300 configured to engage a bottom cap having more knurls. This example also includes an opening 322 formed at a second end 304 of tool 300 for receiving a bit of a driving tool, such as a ratchet drive or wrench. In this example, there are twenty-four splines 318, formed on the inner wall 314 of the apparatus 300 and the number of splines can vary.

In one example, tool 300 has a quarter inch end opening 322 to receive a driver and splines 318 formed with a depth of 0.03 inches. In this example, the inner surface 314 is formed with a maximum diameter of 0.775 inches, from which the inner surface tapers, with splines formed to a maximum diameter of 0.835 inches, e.g. the depth of each of the V shaped splines is 0.03 inches from inner surface 314. A socket preferably has a minimum wall thickness of 0.020 inches to maintain structural integrity.

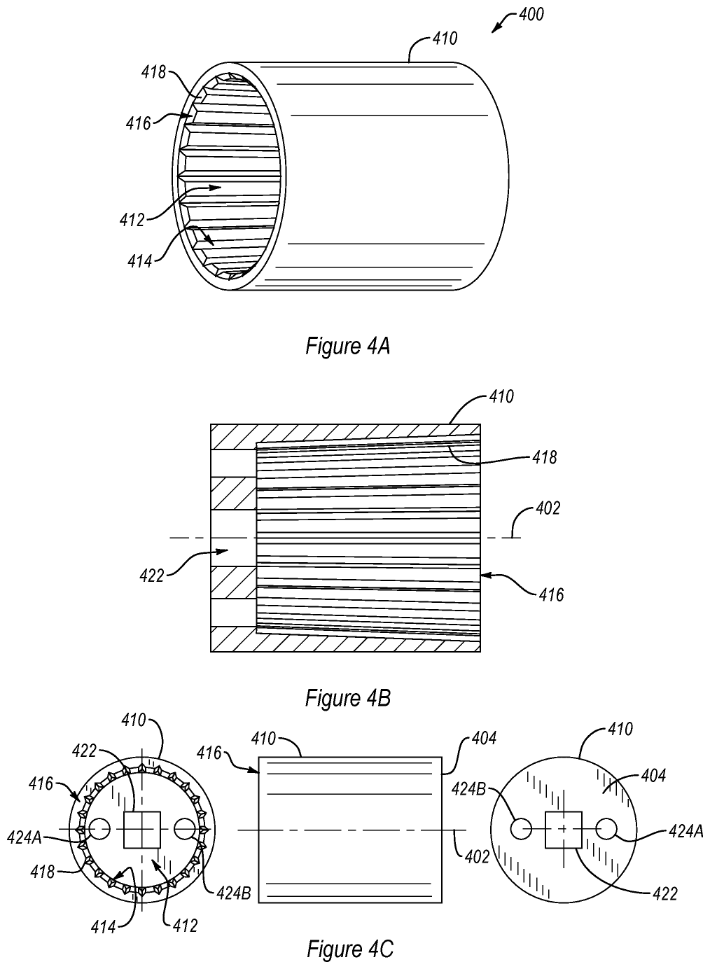

FIG. 4A is a perspective view schematic diagram that illustrates another example of an apparatus 400 for valve cap removal according to certain aspects of the present invention having holes 424A and 424B formed in one end 404 of body 410 to accommodate use of an impact driver.

Similar to the example of FIG. 3A-C above, tool or socket 400 has a body 410, which can be metal or another durable material, with a chamber 412 formed therein along a longitudinal axis 402 of the tool, where the chamber 412 includes at an opening 416 formed in a first end of the tool 400 for receiving a bottom cap of a valve, such as a knurled bottom cap of a trumpet valve.

An inner wall surface 414 of the chamber 412 is tapered from the opening 416 of the chamber 412 toward a second end 404 of tool 400 so that a cross sectional radius of the chamber 412 reduces with respect to the longitudinal axis. The taper of the inner wall surface 414 can provide for the tool 400 to accommodate different sizes and configurations of valve bottom caps.

In this example, twenty-four splines 418 are formed in the inner surface 414 of the apparatus that are set apart from one another and have a V shaped cross section. The angle of the V shaped cross section of splines 418 can vary without departing from the teachings of the present disclosure.

The perspective view of FIG. 4A illustrates chamber 412 formed in body 410, where the chamber 412 includes at an opening 416 for receiving a knurled valve bottom cap. The perspective view also illustrates tapered inner wall surface 414 within which a plurality of splines 418 are formed for engaging a bottom cap.

FIG. 4B is a cut away side view schematic diagram of the apparatus 400 for valve cap removal example of FIG. 4A having additional holes formed in a drive end of the apparatus to accommodate a spanner. A spanner can be useful for removing bottom caps that have high levels of corrosion. A knockout punch can be useful for removing caps lodged in the tool after removal from a valve casing.

Tool 400 can be applied to a valve cap inserted into opening 416 in tool 400 until the knurls of a valve cap engage splines 418 formed in tool 400. The tool 400 can be rotated, such as using an impact wrench engaged with opening 422 or a spanner or knockout punch engaged with holes 424A and 424B formed in a drive end 404 of the apparatus in order to rotate the apparatus 400, such that the splines 418 grip the knurls of a valve cap and rotate the cap to remove it from a valve.

FIG. 4C is a schematic drawing illustrating one example of the relative size, position and dimensions for features and each end of tool 300 with respect to a body 410 of the example apparatus 400 of FIGS. 4A and 4B in accordance with certain examples of the disclosed solution. In this example, the end view illustrates chamber 412 formed in body 410 centered on longitudinal axis 402. Chamber 412 includes opening 416 for receiving a knurled valve bottom cap.

The end view also illustrates tapered inner wall surface 414 within which splines 418 are formed for engaging a bottom cap. Splines 418 are formed in inner surface wall 414 along the inner circumference of chamber 412. The number of splines can be different for differing implementations. For example, more splines in a tool 400 configured to engage a bottom cap having more knurls. This example also includes an opening 422 formed at a second end 404 of tool 400 and holes 424A and 424B for receiving bits of a driving tool, such as an impact driver. In this example, there are twenty-four splines 418, formed on the inner wall 414 of the apparatus 400.

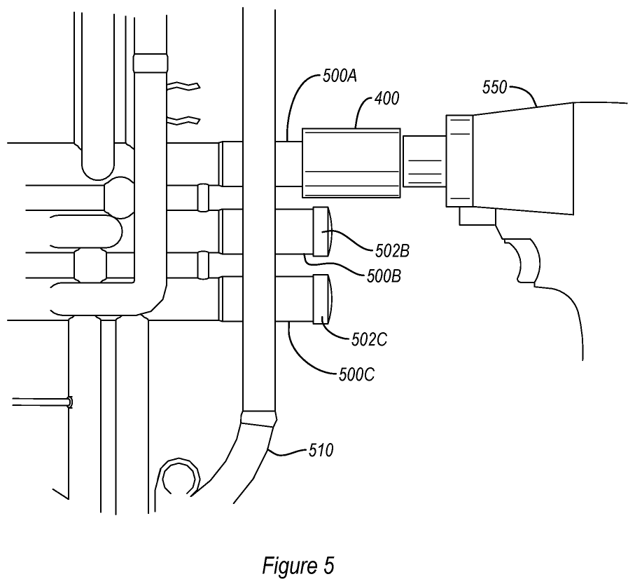

FIG. 5 is a schematic diagram illustrating an example of the apparatus or socket 400 for valve cap removal of FIGS. 4A-C engaged with a valve bottom cap 502 of a trumpet 510 having valves 500A-C and driven by an impact driver 550 according to certain aspects of the present invention.

The apparatus 400 can have a square-broached hole 422 formed therein to accommodate a hex-to-square drive adaptor for impact wrench 550 and can include holes 424A and 424B. In the example of FIG. 5, socket 400 is applied to a bottom cap for valve 500A such that the bottom cap is fully inserted into chamber 412 so that the bottom cap is not externally observable. Splines 418 formed in inner surface wall 414 of socket 400 engage knurls on the bottom cap.

Activation of impact driver 550 applies rotational force to socket 400, which transfers the force to bottom cap of valve 500A via splines 418 engaged with knurls of the bottom cap. The rotational force and the impact provided by driver 550 can loosen and rotate the bottom cap in order to remove the bottom cap from valve 500A. Bottom caps 502B and 502C can be similarly removed using socket 400 and driver 550.

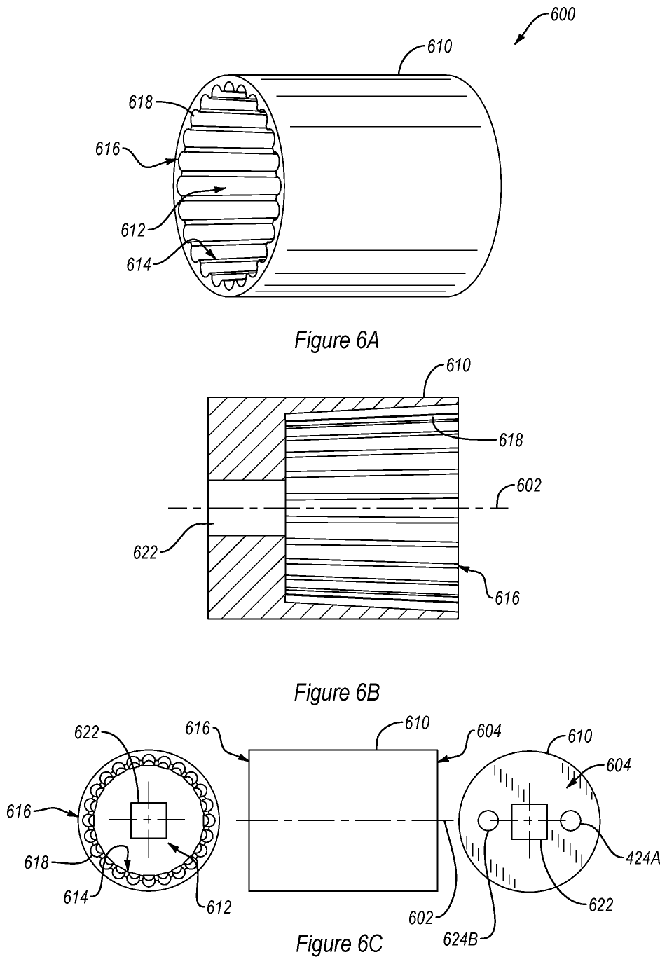

FIG. 6A is a perspective view schematic diagram that illustrates another example of an apparatus 600 for valve cap removal with rounded or scalloped splines according to certain aspects of the present invention. The rounded or scalloped cross section of the splines or grooves can be easier to fabricate in some implementations.

Similar to the example of FIGS. 3A-C, FIGS. 4A-C and FIG. 5A-C above, tool or socket 600 has a body 610, which can be metal or another durable material, with a chamber 612 formed therein along a longitudinal axis 602 of the tool, where the chamber 612 includes at an opening 616 formed in a first end of the tool 600 for receiving a bottom cap of a valve, such as a knurled bottom cap of a trumpet valve.

An inner wall surface 614 of the chamber 612 is tapered from the opening 616 of the chamber 612 toward a second end 604 of tool 600 so that a cross sectional radius of the chamber 612 reduces with respect to the longitudinal axis. The taper of the inner wall surface 614 can provide for the tool 600 to accommodate different sizes and configurations of valve bottom caps.

In this example, twenty-four splines 618 are formed in the inner surface 614 of the apparatus that are set apart from one another and have a C shaped, semi-circular or scalloped cross section. The shape and size of the C shaped cross section of splines 618 can vary without departing from the teachings of the present disclosure.

The perspective view of FIG. 6A illustrates chamber 612 formed in body 610, where the chamber 612 includes at an opening 616 for receiving a knurled valve bottom cap. The perspective view also illustrates tapered inner wall surface 614 within which a plurality of C shaped splines 618 are formed for engaging knurls of a bottom cap.

FIG. 6B is a cut away side view schematic diagram of the apparatus 600 for valve cap removal example of FIG. 6A. Tool 600 can be applied to a valve cap inserted into opening 616 in tool 600 until the knurls of a valve cap engage C shaped splines 618 formed in tool 600. The tool 600 can be rotated, such as using an impact wrench engaged with opening 622, e.g. a broached opening, formed in the apparatus in order to rotate the apparatus 600, such that the splines 618 grip the knurls of a valve cap and rotate the cap to remove it from a valve.

FIG. 6C is a schematic drawing illustrating one example of the relative size, position and dimensions for features and each end of tool 600 with respect to a body 610 of the example apparatus 600 of FIGS. 6A and 6B in accordance with certain examples of the disclosed solution. In this example, the end view illustrates chamber 612 formed in body 610 centered on longitudinal axis 602. Chamber 612 includes opening 616 for receiving a knurled valve bottom cap.

The view also illustrates tapered inner wall surface 614 within which shaped splines 618 are formed for engaging a bottom cap. Splines 618 are formed in inner surface wall 614 along the inner circumference of chamber 612. The number of splines can be different for differing implementations. For example, more splines in a tool 600 configured to engage a bottom cap having more knurls. This example also includes an opening 622 formed at a second end 604 of tool 600 and holes 624A and 624B for receiving bits of a driving tool, such as an impact driver. In this example, there are twenty-four C shaped splines 618, formed on the inner wall 614 of the apparatus 600.

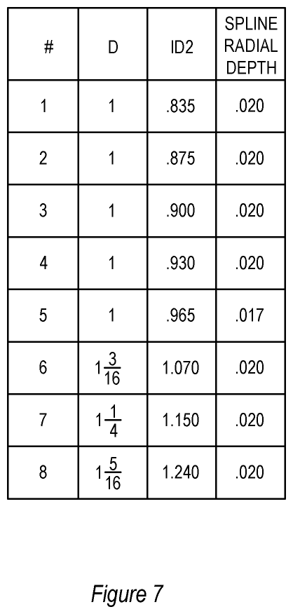

FIG. 7 is a table illustrating additional examples of dimensions for different sized sockets. Sockets or tools with outer diameters greater than one inch and shown in the table of FIG. 7 can accommodate brass instruments such as the cornet, flugel horn, French horn, alto horn or euphonium.

In the table, the numbers one through eight, in the column marked #, are ordinal numbers designating a series of sockets increasing in cap diameter capacity. The first entry (#1) accommodates the smallest cap. The last entry (#8) accommodates the largest cap in this series.

Column D represents a nominal outer diameter of each numbered socket, an outer diameter of a tool body. Socket numbers 1, 2, 3, 4 and 5 can be made from rod stock one inch in diameter. Socket number 6 can be made from rod stock 1 and 3/16 inches in diameter, socket number 7 can be made from rod stock 1 and ¼ inches in diameter, and number 8 can be made from rod stock 1 and 5/16 inches in diameter.

The numbers under columns ID2 and Spline Radial Depth are dimensions in decimal inches. ID2 represents an inner diameter of the inner surface of the chamber formed in the tool body at the opening to the chamber through which a valve cap is inserted. ID2 sizes are the larger of two internal diameters, the other diameter being ID1, which are not shown in this example, are generally determined by the bored taper angle of the chamber formed in the tool body. As the inner surface wall of the chamber tapers, the internal diameters become smaller corresponding to the depth into the chamber of the socket. The radial depth numbers can be useful for fabrication. The radial depth dimensions are examples of maximum penetration dimensions from first contact of the tapered end mill with the taper-bored raw material, moving radially outward from center.

Note that other sockets can have different dimensions without departing from the disclosed technology.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements and configurations of the components depicted in the drawings or described above, as well as components and steps not shown or described are possible. For example, a user with access to an ordinary bench lathe could shorten the over-all length of the apparatus or reduce the diameter near the opening of the apparatus in order to clear other instrument features, such as cross bracing elements or adjacent tubing, or to clear closely-spaced adjacent valve caps.

Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

We claim:

1. An apparatus for removing valve caps from an instrument, the apparatus comprising a rigid tool body wherein:
a chamber is formed along a longitudinal axis of the tool body, where the chamber includes an opening formed in a first end of the tool body for receiving a bottom cap of a valve; and
an inner wall surface of the chamber that tapers from the opening of the tool body such that a cross sectional radius of the chamber reduces with respect to the longitudinal axis; and
a plurality of splines formed in the internal wall surface for engaging knurls on a bottom cap of the valve.

2. The apparatus of claim 1, wherein the splines are formed with a V shaped cross section.

3. The apparatus of claim 1, wherein the splines are formed with a semi-circular or scalloped cross section.

4. The apparatus of claim 1, where the tool body includes a shank formed in a second end of the tool body that is opposite the first end, the shank being configured to receive a driver for applying torque to the tool body.

5. The apparatus of claim 1, where the tool body includes one or more openings formed in a second end of the tool body that is opposite the first end, the one or more openings being configured to receive a driver for applying torque to the tool body.

6. The apparatus of claim 1, where the plurality of splines comprises at least twenty-four splines.

7. A method for removing valve caps from an instrument, the method comprising:
providing an apparatus having a rigid tool body with a chamber formed therein along a longitudinal axis of the tool body, where the chamber includes an opening formed in a first end of the tool body for receiving a bottom cap of a valve, and an inner wall surface of the chamber that is tapered from the opening of the tool body such that a cross sectional radius of the chamber reduces with respect to the longitudinal axis, and a plurality of splines formed in the internal wall surface for engaging knurls on a bottom cap of a valve;
applying the apparatus to the bottom cap of the valve such that the knurls of the bottom cap are engaged by the plurality of splines; and
applying rotational torque to the tool body to remove the bottom cap.

8. The method of claim 7, where:
the method includes forming one or more holes in a second end of the tool body that is opposite the first end of the tool body; and
the step of applying rotational torque to the tool body to remove the bottom cap comprises:
inserting a bit of a driver into at least one of the one or more holes in the second end of the tool body; and
applying force to the driver to provide rotational torque to the tool body.

9. The method of claim 8, where the driver comprises one of a ratchet driver, an impact driver, a spanner wrench and a square shank L wrench.

10. The method of claim 7, where:
the method includes forming a shank in a second end of the tool body that is opposite the first end; and
the step of applying rotational torque to the tool body to remove the bottom cap comprises:
applying a wrench to the shank; and
applying force to the wrench to provide rotational torque to the tool body.

11. The method of claim 7, where the splines formed in the internal wall surface have a V shaped cross section.

12. The method of claim 7, where the splines formed in the internal wall surface have a semi-circular or scalloped cross section.

13. A socket for removing valve caps from an instrument, the socket comprising a rigid body wherein:
a chamber is formed along a longitudinal axis of the rigid body, where the chamber includes an opening formed in a first end of the rigid body for receiving a bottom cap of a valve; and
an inner wall surface of the chamber that tapers from the opening of the rigid body such that a cross sectional radius of the chamber reduces with respect to the longitudinal axis; and
a plurality of splines formed in the internal wall surface for engaging knurls on a bottom cap of the valve.

14. The socket of claim 13, wherein the splines are formed with a V shaped cross section.

15. The socket of claim 13, wherein the splines are formed with a semi-circular or scalloped cross section.

16. The socket of claim 13, where the rigid body includes a shank formed in a second end of the rigid body that is opposite the first end, the shank being configured to receive a driver for applying torque to the rigid body.

17. The socket of claim 13, where the rigid body includes one or more openings formed in a second end of the rigid body that is opposite the first end, the one or more openings being configured to receive a driver for applying torque to the rigid body.

18. The socket of claim 13, where the plurality of splines comprises at least twenty-four splines.
